(19) United States
(12) Patent Application Publication
(10) Pub. No.: US 2018/0211233 A1
(43) Pub. Date: Jul. 26, 2018

(54) Systems and Methods for Use in Permitting Network Transactions Based on Expected Activity to Accounts

(71) Applicant: MASTERCARD INTERNATIONAL INCORPORATED, Purchase, NY (US)

(72) Inventor: Ashutosh Gupta, Uttar Pradesh (IN)

(21) Appl. No.: 15/413,998

(22) Filed: Jan. 24, 2017

(51) Int. Cl. G06Q 20/10; G06Q 20/40

(52) U.S. Cl. CPC G06Q 20/10; G06Q 20/4016

(57) ABSTRACT

Systems and methods are provided for permitting transactions to proceed having associated indicators of fraud. One exemplary method includes identifying, by a computing device, a segment for a consumer based on one or more demographic factors associated with the consumer, and retrieving, by the computing device, a change in spending value associated with the segment. The method also includes determining, by the computing device, a net revenue for decline of a transaction to a payment account associated with the consumer based on the change in spending value and at least one of a future spending value, an interchange rate for an issuer of the account, and a rate of false positive declines for the issuer. The method further includes comparing the net revenue to a threshold, wherein the transaction is able to be permitted when the threshold is satisfied despite the transaction having an associated indicator of fraud.

### FIELD

The present disclosure generally relates to systems and methods for use in permitting network transactions based on expected activity to accounts (e.g., to payment accounts, debit accounts, etc.), and in particular, to systems and methods for permitting network transactions associated with decline indicators (e.g., transactions that are identified as declined for one or more reasons, etc.) based on expected future spending values associated with the corresponding accounts.

### BACKGROUND

This section provides background information related to the present disclosure which is not necessarily prior art.

Purchases of products by consumers, for example, involving goods and services, are often funded through transactions to payment accounts. In general, the transactions are coordinated through merchants (offering the products for purchase), acquirers associated with the merchants, one or more payment networks, and issuers of the payment accounts to the consumers. It is known for payment networks and issuers to employ fraud prevention services, whereby suspicious transactions to the consumers' payment accounts are declined as potentially fraudulent (e.g., the transactions are associated with decline indicators, etc.). The decline of fraudulent transactions has the potential to save the issuers and/or the payment networks substantial sums of money over given periods of time. However, the fraud prevention services must be restricted, and precise, to avoid declining transactions that are not fraudulent.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in permitting network transactions based on expected activity to accounts;

FIG. 2 is a block diagram of a computing device that may be used in the exemplary system of FIG. 1; and

FIG. 3 is an exemplary method suitable for use with the system of FIG. 1 for permitting a payment account transaction, despite the payment account transaction having an indicator of decline for suspicion of fraud, when a net revenue for a payment account involved in the transaction, based on an expected future spending value, satisfies at least one threshold.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Consumers often purchase products (e.g., goods, services, etc.) from merchants by use of payment accounts, through payment account transactions. Issuers of the payment accounts are involved in the payment account transactions to either approve or decline the transactions. Often, the issuers employ fraud schemes by which some of the transactions may be declined for suspicion of fraud as indicated by one or more circumstance associated the transactions (e.g., time of day, location of merchant, dollar amount in excess of threshold, merchant category code (MCC), merchant name, merchant type, etc.). When the fraud schemes work properly, fraudulent transactions are avoided (i.e., the issuers correctly decline the fraudulent transactions and approve the valid transactions). When the fraud protection schemes work improperly, though, valid transactions may be incorrectly declined. Such incorrectly declined transactions are broadly referred to as false positive declines. In these instances, the issuers may lose revenue associated with the improperly declined transactions, and may also potentially lose future transactions by the consumers.

Uniquely, the systems and methods herein permit incorporation of the potential loss of future revenue associated with improperly declined transactions to consumer payment accounts into the ultimate determinations by the issuers of whether to decline current transactions for reasons related to suspected fraud (or for other reasons), or not. In particular, for example, for a transaction performed by a consumer that is declined by a fraud scheme, an impact engine is provided to determine a change value for the consumer or for a segment of consumers (to which the consumer is a member) in response to the decline of the transaction. By combining the change value with an expected spending value for the consumer (based on his/her payment account), the impact engine is then able to determine a net revenue for the decline of the transaction (e.g., expressed in dollars, expressed as an abstract score, etc.). When the net revenue satisfies a threshold, the issuer of the consumer's payment account or other decision maker may determine that it is more profitable to permit the declined transaction to still proceed, rather than risk the loss of expected future spending by the consumer to the payment account (if the decline ends up being a false positive decline). In this manner, the issuer or other decision maker is able to more globally and completely consider the decision to decline, or not decline, the transaction (in a greater sense than simply based on the fraud scheme), thereby potentially improving the issuer's ability to generate revenue and operate more profitably.

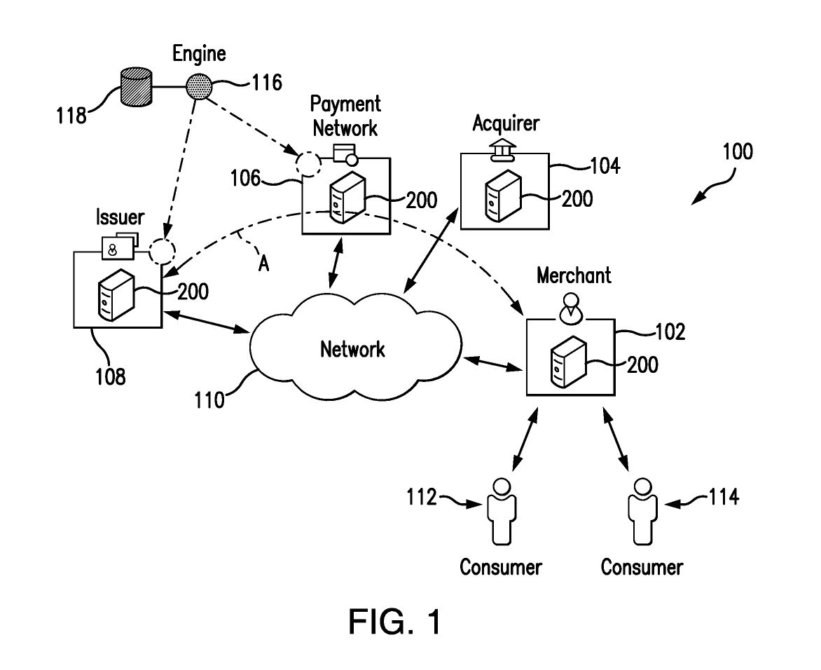

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, for example, depending on interactions between various parts in the exemplary embodiments, processing of payment transactions, implementation of fraud schemes, etc.

The illustrated payment system 100 generally includes a merchant 102, an acquirer 104 associated with the merchant 102, a payment network 106, and an issuer 108 configured to issue payment accounts to consumers, each coupled to (and in communication with) network 110. The network 110 may include, without limitation, one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts of the system 100, or even combinations thereof. In one example, the network 110 includes multiple different networks, where different ones of the multiple networks are accessible to different ones of the illustrated components in FIG. 1. In particular, for example, the network 110 may include a private payment transaction network made accessible by the payment network 106 to the acquirer 104 and the issuer 108 and, separately, the public Internet, which is accessible as desired by the merchant 102, the acquirer 104, other parts of the system 100, etc.

The merchant 102 in the payment system 100 is configured to offer products (e.g., goods and/or services, etc.) for sale to consumers, including, for example, to consumer 112 and/or consumer 114. The merchant 102 may include a brick-and-mortar merchant having one or more physical locations for selling the products to the consumers. In addition (or alternatively), the merchant 102 may include an online merchant, having a virtual location on the Internet (e.g., one or more websites accessible through the network 110, etc.) and/or having/being associated with one or more web-based applications that permit consumers to initiate transactions for the products offered by the merchant 102. Regardless, the acquirer 104 is associated with the merchant 102, and in general, issues an account to the merchant 102 through which the transactions for the merchant's products may be directed and/or coordinated (so that the merchant 102 can be paid in connection with products purchased from the merchant 102 by the consumers).

In this exemplary embodiment, each of the consumers 112 and 114 has a payment account issued thereto by the issuer 108, and through which the consumers 112 and 114 may initiate and complete payment account transactions for the purchase of products (e.g., at the merchant 102, etc.). The consumers 112 and 114 are each associated with demographics such as, for example, income amount, age, familial makeup, gender, marital status, residential location, etc. In the examples described herein, for purposes of illustration (and without limitation) the consumer 112 is a 25 year old male with an annual income of $54,650, no children, and a residence within the 12345 postal code. And, the consumer 114 is a 51 year old female with an annual income of $210,000, four children, and a residence within the 12355 postal code. In addition, each of the consumers 112 and 114 is further identified to one or more segments based on his/her demographics. Each of the segments, then, is associated with data relating to before- and after-decline spending, and also data relating to spending for consumers who don't face any declines (to determine a spending drop in the given segment due to transaction declines). This will be described more hereinafter. Further, in various embodiments, each of the consumers 112 and 114 is associated with a transaction history defined by his/her payment account (e.g., for use in determining total life spending to his/her payment account, etc.). It should be appreciated that the consumers 112 and 114 may be associated with other demographics, other segments than described herein, and/or other transaction histories within the scope of the present disclosure, and that other consumers may be associated with the same, different and/or additional demographics, segments and/or transaction histories, for use as described herein.

In general in the system 100, from time to time, the consumers 112 and 114 initiate payment account transactions for the purchase of products from the merchant 102. In one exemplary transaction, the consumer 112 (for example) purchases a product from the merchant 102, whereupon the consumer 112 presents to the merchant 102 a payment device (e.g., a payment card, etc.) associated with his/her payment account. In turn, the merchant 102 is configured to capture payment account information from the payment device and to communicate an authorization request for the transaction to the acquirer 104. The acquirer 104 then communicates the authorization request, along path A in FIG. 1, to the issuer 108, through the payment network 106 (e.g., through MasterCard®, VISA®, Discover®, American Express®, etc.), to determine whether the payment account is in good standing and whether there is sufficient credit or funds to complete the purchase. If the issuer 108 accepts/approves the transaction, the issuer 108 transmits an authorization reply indicating the approval back to the acquirer 104 and the merchant 102, thereby permitting the merchant 102 to continue in the transaction. The transaction is later cleared and/or settled by and between the merchant 102 and the acquirer 104, and by and between the acquirer 104 and the issuer 108 (via appropriate agreements). If the issuer 108 declines the transaction, however, the issuer 108 transmits an authorization reply indicating the decline back to the acquirer 104 and the merchant 102, thereby permitting the merchant 102 to stop the transaction (or seek alternate funding). The issuer 108 may decline the transaction for various reasons, for example, insufficient funds/credit, status of the account, and/or a suspicion of fraud (e.g., as defined by one or more fraud schemes employed by the issuer 108, etc.).

It should be appreciated that a transaction by the consumer 114 at the merchant 102 will proceed in substantially the same manner as the exemplary transaction described above.

Transaction data is generated, collected, and stored as part of the above interactions among the merchant 102, the acquirer 104, the payment network 106, and/or the issuer 108, etc. The transaction data, in this exemplary embodiment, is stored at least by the payment network 106 (e.g., in a data structure associated with the payment network 106, etc.). Additionally, or alternatively, the transaction data may be stored in any desired manner in the system 100. With that said, transaction data may include, for example, payment account numbers (e.g., primary account numbers (PANs), etc.), amounts of transactions, merchant IDs, merchant category codes (MCCs), region codes for merchants involved in transactions and/or for point-of-sale (POS) terminals associated with the merchants (or other merchant location identifiers and/or transaction location identifiers), merchant names, dates/times of transactions, products purchased and related descriptions or identifiers, etc. It should be appreciated that more or less information related to transactions, as part of either authentication of consumers, authorization of transactions, clearing of transactions, and/or settling of transactions, etc. may be included in transaction data and stored within the system 100, at the merchant 102, the acquirer 104, the payment network 106, and/or the issuer 108. Further, data unrelated to particular payment accounts may be collected by a variety of techniques, and similarly stored within the system 100.

In various exemplary embodiments, consumers and/or merchants involved in the different transactions herein are prompted to agree to legal terms associated with their payment accounts, for example, during enrollment in their accounts, etc. In so doing, the consumers and merchants may voluntarily agree, for example, to allow issuers of the payment accounts, payment networks, etc., to use data collected during enrollment and/or collected in connection with processing transactions to the payment accounts, subsequently, for one or more of the different purposes described herein.

While only one merchant 102 and two consumers 112 and 114 are illustrated in FIG. 1, it should be appreciated that any number of merchants and/or consumers, as described herein, may be included in different embodiments of the system 100. Likewise, a different number of acquirers, payment networks, and/or issuers may be included. For example, different merchants may have one or more different acquirers, and different consumers may employ payment accounts issued by one or more different issuers.

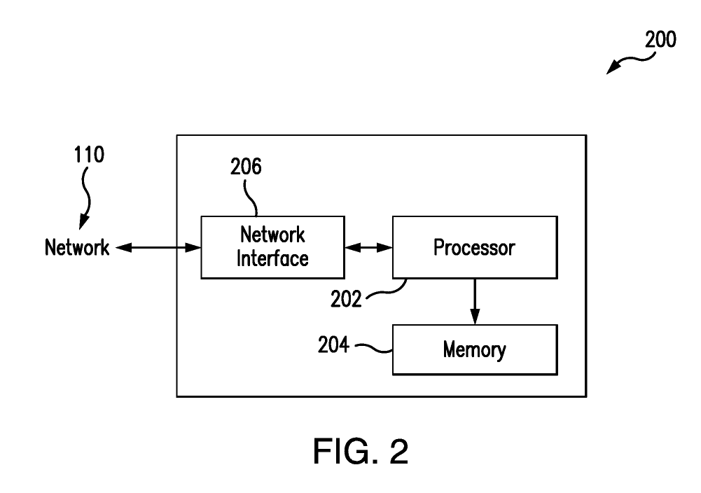

FIG. 2 illustrates an exemplary computing device 200 that can be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, for example, each of the merchant 102, the acquirer 104, the payment network 106, and the issuer 108 are illustrated as including, or being implemented in, computing device 200, coupled to (and in communication with) the network 110. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, demographic data/profiles, spending profiles, change values, consumer expected spending values, interchange rates, fraud rates for issuers, associated probabilities, and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition, the illustrated computing device 200 also includes a network interface 206 coupled to (and in communication with) the processor 202 and the memory 204. The network interface 206 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 206) incorporated into or with the processor 202.

Referring again to FIG. 1, the system 100 also includes an impact engine 116, and a data structure 118 coupled to the impact engine 116. The impact engine 116 is illustrated as a standalone device (e.g., consistent with computing device 200, etc.), but as illustrated by the broken lines may be incorporated and/or integrated in whole or in part with the payment network 106 and/or the issuer 108, as desired (e.g., as part of the computing device 200 therein, as a separate computing device, etc.). The data structure 118 is also illustrated as a standalone device, but may be incorporate in whole or in part into the impact engine 116, or may be incorporated into the payment network 106 and/or the issuer 108. The data structure 118 includes, among other things, transaction data for the consumers 112 and 114, and numerous other consumers (not shown), with the transaction data therein generally being specific, in this exemplary embodiment, to the particular payment accounts issued to the consumers 112 and 114 by the issuer 108 (and the various payment accounts issued to the other consumers). In addition to the transaction data, the data structure 118 may further include demographic data for the consumers' payment accounts and/or for the consumers 112 and 114 themselves, as well as interchange rates (e.g., the percentage of revenue for each transaction, etc.), fraud rates for the issuer 108 and other issuers, probabilities per issuer of a decline for fraud being a false positive decline (e.g., a probability of false positive decline, etc.), different segments for the consumers 112 and 114, and other information as described herein per consumer (e.g., other information for each of the consumers 112 and 114, etc.) such as payment account information and corresponding issuer information, etc. The demographic data for the consumers 112 and 114, when stored in the data structure 118, may include, as suggested above and without limitation, age, income, gender, familial makeup, marital status, race, religion, education, occupation, location, etc. (and may be used to identify the consumers 112 and 114 into one or more particular segments). And, the fraud rates for the issuer 108 and other issuers, when stored in the data structure 118, may be based on and/or dependent on, for example, the particular issuer, the type(s) of payment product(s) provided by the issuer, locations of transactions involving the issuer, types of such transactions (e.g., ATM transactions, electronic commerce transactions, POS transactions, domestic transactions, cross-border transactions, chip-card transactions, magnetic swipe transactions, contactless transactions, phone-order transactions, etc.), etc.

In this exemplary embodiment, the impact engine 116 is configured, for example, by computer-executable instructions, to identify one or more segments for the consumers and/or payment accounts in the data structure 118 (and populate the various segments with data as described in the following paragraphs). In connection therewith, the impact engine 116 generates a demographic profile for each of (and generally as a basis for) the identified segments (and more specifically, for the consumers associated with the payment accounts included in the identified segments). In particular, for example, in connection with generating the demographic profile for each of the segments, the impact engine 116 may be configured to subject the consumer demographic data for the identified payment accounts to one or more clustering methodologies, whereupon certain clusters emerge with consumers therein having like demographics (such that payment accounts for consumers having similar demographics are clustered together). Additionally, or alternatively, the impact engine 116 may be configured to employ demographic ranges identified by other methods or by one or more users associated with the impact engine 116 (e.g., as part of predetermined demographic profiles, etc.). In either event, the demographic profiles are then defined for each of the various segments, into which the corresponding payment accounts and/or consumers are then placed/associated (e.g., within the data structure 118, etc.). Exemplary segments and their demographic profiles are illustrated in Table 1.

TABLE 1

| | | | | | Location |
|---|---|---|---|---|---|
| | Income | Age | Children | Gender | (Postal Code) |
| Segment #1 | $0-50k | 18-26 | 0-1 | M or F | 12345, 12355, |
| | | | | | 12445 |
| Segment #2 | $51-125k | 18-26 | 0-2 | M | 12345, 12344, |
| | | | | | 12364, 12355 |
| Segment #3 | $80-215k | 30-52 | 2-4 | F | 12346, 12345, |
| | | | | | 12355 |
| . . . | . . . | . . . | . . . | . . . | . . . |

It should be appreciated that any number and/or type of segments may be created based on the demographic data associated with the payment accounts and/or the consumers included in the data structure 118. In addition, the segments will generally be mutually exclusive to at least one of the demographics upon which the segment is based. That is, a particular demographic will generally fall into only one segment. However, different consumers may still be included in multiple different segments. With that said, it should be appreciated that the segments may, in other embodiments, be defined and/or identified by factors other than demographics. In particular, in one example, the impact engine 116 may be configured to assign payment accounts and/or consumers to segments based on transaction history profiles, whereby consumers with like spending habits may be segmented together (in addition to or regardless of their demographic data).

Once the segments are identified in the system 100, the impact engine 116 is configured to identify payment accounts within the segments that have at least one false positive decline, referred to herein as “affected” payment accounts. Conversely, the payment accounts within the segments that do not include at least one false positive decline are referred to herein as “control” payment accounts. Then, once the various payment accounts are identified, the impact engine 116 is configured to generate a past spending profile and a future spending profile for each of the affected payment accounts. The past spending profile includes a range from the date of the at least one false positive decline for the given payment account, for a period into the past, where the period may include one month, two months, six months, one year, 15 years, other time period, etc. The future spending profile includes a range from the date of the at least one false positive decline for the given payment account, for a period into the future, where the period may include one month, two months, six months, one year, 15 years, or other time period, etc. For example, for either profile, the period may be selected by a user associated with the impact engine 116 to be indicative of the “lifecycle” or “lifetime” spending to the payment account (e.g., an average period that a consumer is active with an issuer of the corresponding payment account for the given payment account product, etc.). In this exemplary embodiment, the impact engine 116 is also configured to compile spending profiles, in the same manner, generally, for the control payment accounts.

Next, the impact engine 116 is configured to determine a difference in value between the future spending profiles for the affected payment accounts and the control payment accounts for each of the segments, which generally indicates a difference in future spending by consumers in the particular segments when the consumers are subjected to a false positive decline (e.g., a spending change value (broadly, a change value), etc.). Once determined, the impact engine 116 is configured to store the spending change values, per segment (or per sub-segment), in the data structure 118 for use as described below. Table 2 illustrates exemplary spending change values for the segments identified in Table 1 (the negative values indicate the decrease in spending).

TABLE 2

| | Spending Change Value |
|---|---|
| Segment #1 | −10% |
| Segment #2 | −4% |
| Segment #3 | −19% |
| . . . | . . . |

For example, regarding Segment #1 in Table 2, an average spend amount for an affected group of payment accounts in a before-decline period (e.g., January 15 to June 15, etc.) may be $1,000 (as a past spending profile for the segment). And, an average spend amount for the affected group of payment accounts in a post-decline period (e.g., July 15 to December 15, etc.) may be $950 (as a future spending profile segment). In addition, an average spend amount for a control group of payment accounts for the same two periods may be $1,000 and $1,050, respectively. Thus, for Segment #1, the affected group of payment accounts includes a decline of 5% in spending from the before-decline period to the post-decline period, while the control group includes an increase of 5% in spending for the same periods. As such, the total impact on spending for the payment accounts in Segment #1, based on the false positive declines for the payment accounts included in Segment #1, is a 10% loss in spending (i.e., −5%−5%=−10%), or a −10% spending value change. Similar determinations can be performed for Segment #2 and Segment #3 to obtain the respective spending value changes of −4% and −19%.

It should be appreciated that the demographic segments and/or spending change values described above may be different, or determined differently, in other system embodiments. For example, while the spending change values above are based on segmented transaction data, other conditions may be indicated in the spending change values and/or delineated between different spending change values. In one example, the impact engine 116 may be configured to generate, for each segment, one spending change value when the false decline transaction is a “card not present” transaction and one spending change value when the false decline transaction is a “card present” transaction (broadly, the spending change value may be based on a condition of the transaction). As such, a variable associated with the consumer's potential embarrassment of being declined in person, or not, may be accounted for and further used to determine the impact of the false positive decline.

In addition, the impact engine 116 is configured to determine a consumer expected spending value (CESV) for each of the payment accounts and/or consumers included in the data structure 118, and from there to determine a consumer future lifetime value (CFLV) (e.g., a potential future revenue the issuer 108 would earn through interchange on the consumer's payment account, etc.) (both broadly future spending values). The CESV may be determined based on, for example (and without limitation), the issuer of the payment account (e.g., issuer 108, etc.), an average lifetime spend for a particular payment account product issued by the issuer less a spend amount performed to the payment account product by a particular consumer, the issuer's country, a type of the payment account, a history of the payment account, etc. For example, for a given payment account product issued by the issuer 108 to the consumer 112, where the average lifetime spend for the payment account product is $30,000 (as an average for all consumers having the payment account product since being issued by the issuer 108) and where the consumer 112 has spent $10,000 using the payment account product since receiving the product, the CESV may be determined as $30,000−$10,000=$20,000. Then in this example, when the interchange rate (IR) for the issuer 108 is 1.6%, the CFLV may be determined as $20,000×1.6%=$320.

With that said, and generally separate from populating the data structure 118 as described above, from time to time, a transaction will be declined by an issuer based on an indicator of fraud included in the transaction. Such an indicator may include, for example, a transaction of high amount at an unknown merchant, or four to five consecutive transactions to a payment account in a short span of time, etc. In response to such decline (e.g., upon receiving an authorization reply including such decline, etc.), the impact engine 116 is configured to identify a segment for the payment account involved in the declined transaction and/or consumer involved in the transaction (e.g., identify the payment account for the declined transaction to one of the segments included in Table 1, etc.). From the identified segment, then, the impact engine 116 is configured to identify from the data structure 118 the spending change value expected for a false positive decline of a transaction in the identified segment (e.g., one of the values in Table 2, etc.) and further to determine a net revenue (e.g., as a score, as a dollar amount, etc.) for declining the particular transaction based on: the spending change value for the identified segment, the CESV for the particular payment account involved in the transaction, and potentially other information described above. The impact engine 116 (or other entity including, for example, the payment network 106, the issuer 108, etc.) is configured to then compare the net revenue to a threshold (or multiple thresholds) and determine, based on whether the net revenue satisfies the threshold(s), whether to permit the transaction to be declined, or to permit the transaction to proceed (e.g., overrule/override the decline, etc.).

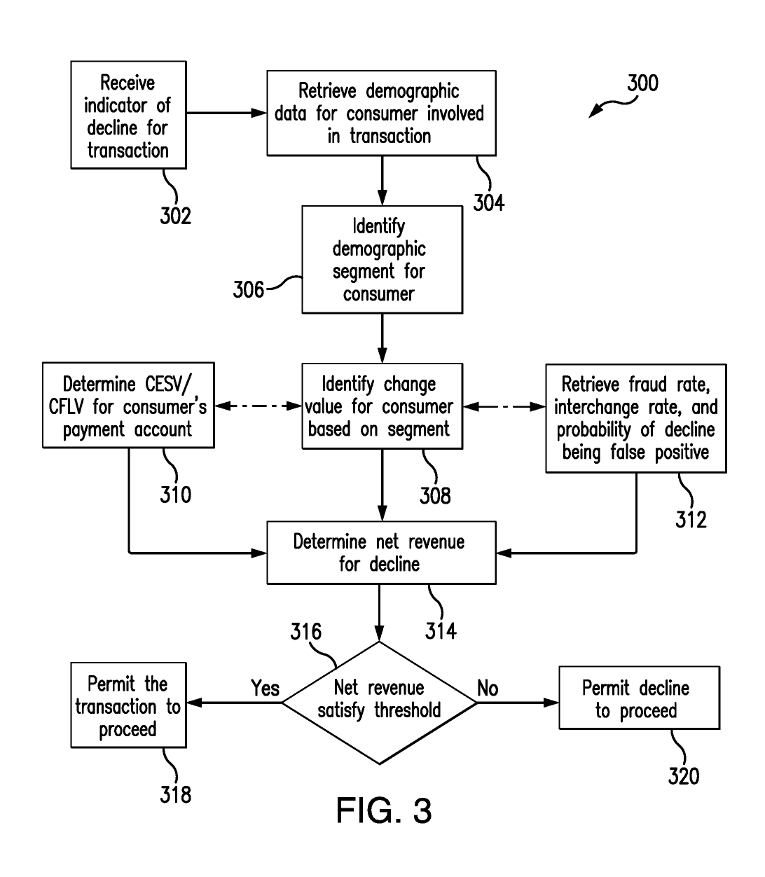

FIG. 3 illustrates exemplary method 300 that can be used in connection with the system 100 (or in connection with other systems herein) for altering rules associated with network transactions based on account lifecycles, etc. (e.g., for permitting payment account transactions despite the payment account transactions having indicators of decline for suspicion of fraud, etc.). The exemplary method 300 is described as implemented in the impact engine 116 of the system 100, with further reference to the data structure 118, the payment network 106, the issuer 108, and the consumers 112 and 114. However, the method 300 could be implemented in one or more other parts of the system 100 in other embodiments (e.g., in the payment network 106 of the system 100, in the issuer 108 of the system 100, etc.). Further, for purposes of illustration, the exemplary method 300 is described herein with reference to the computing device 200. However, the method 300, and other methods herein, should not be understood to be limited to the exemplary system 100, or the exemplary computing device 200. And likewise, the systems and computing devices herein should not be understood to be limited to the exemplary method 300.

In one implementation of the exemplary method 300, the consumer 114 performs a transaction at the merchant 102 in the amount of $125.00. In response, the merchant 102 transmits an authorization request for the transaction to the issuer 108, as described above in the system 100 (with reference to path A in FIG. 1). The issuer 108 employs one or more fraud schemes to evaluate the transaction and determines in this example, based on the fraud scheme(s), that the transaction is suspicious for fraud (e.g., the transaction is a fifth transaction to the consumer's payment account within the last thirty minutes, etc.). In turn, the issuer 108 generates an authorization reply for the transaction and includes an indicator of decline for the transaction in the reply based on the suspicion of fraud. And, the impact engine 116 receives the indicator of decline for the transaction, via the authorization reply, at 302.

In response, the impact engine 116 retrieves demographic data for the consumer 114 (and/or the consumer's payment account), at 304, from the data structure 118, for example, and identifies an appropriate demographic segment for the consumer 114 (and/or the consumer's payment account), at 306. As indicated above, the consumer 114 is a 51 year old female with an annual income of $210,000, four children, and a residence within the 12355 postal code. As such, in this example, and with reference to Table 1 above, the consumer 114 is determined to fit within Segment #3. Once the segment is determined, the impact engine 116 then identifies, at 308, a spending change value associated with the segment. Since the consumer 114 is determined to fit within Segment #3 in this example, the impact engine 116 identifies a spending change value of −19% from Table 2, which indicates the expected change in future spending of the consumer 114 in response to a false positive decline of the given transaction (e.g., if the declined transaction at the merchant 102 ends up being a false positive decline, etc.).

In addition, at 310, the impact engine 116 determines the CESV for the consumer's payment account involved in the transaction with the merchant 102. In particular in the method 300, the impact engine 116 determines the CESV based on an average lifetime spend for the particular payment account issued by the issuer 108 (and used in the transaction by the consumer 114 with the merchant 102) less a spend amount performed to the payment account by the particular consumer 114 since receiving the payment account from the issuer 108. In so doing, the impact engine 116 retrieves necessary data for use in the determination from the data structure 118. For example, the average lifetime spend for the given payment account may be $30,000 (as an average spend by all consumers having the payment account since being issued by the issuer 108) and the total spend by the consumer 114 since receiving the payment account from issuer may be $25,000. In connection therewith, the CESV for the consumer's payment account may be determined as $30,000−$25,000=$5,000. Then in this example, based on the interchange rate (IR) of 1.6% for the issuer 108, the impact engine 116 may determine the CFLV for the payment account as $5,000×1.6%=$80.

And, at 312, the impact engine 116 retrieves the fraud rate for the issuer 108, the interchanges rate (IR) for the issuer 108, and a probability/rate of false positive decline (PFPD) for the issuer 108 from the data structure 118. Once retrieved, the impact engine 116 determines, at 314, the net revenue for the decline of the transaction according to the following algorithm:

Net Revenue=(fraud rate*transaction amount)−(IR*transaction amount)−(PFPD*Spending Change Value*CFLV)

In particular in the above example, the impact engine 116 retrieves a fraud rate for the issuer 108 of 5% (e.g., for every $100 of transactions to the issuer 108 there is $5 in fraud (500 bps fraud rate), etc.), retrieves the interchange rate (IR) for the issuer of 1.6% (based on the given transaction and/or the payment account product used by the consumer 114 in the transaction), and retrieves a PFPD for the issuer 108 of 80% (based on the issuer's past record of false positive declines). The impact engine 116 then determines the net revenue for the decline of the above transaction performed by the consumer 114 at the merchant 102, as follows:

Net Revenue=(5%*$125)−(1.6%*$125)−(80%*19%*$80)=−$7.91

It should be appreciated that, while the net revenue is determined in the above example in dollars, it may alternatively be determined based on any appropriate metric or scale in other examples.

Next in the method 300, once the net revenue is determined, the impact engine 116 determines whether the net revenue satisfies one or more thresholds, at 316. In this example, the threshold is set to $0.00. That is, when the net revenue indicates that the issuer 108 is predicted to have a negative net revenue from declining the transaction, rather than allowing the transaction to proceed (i.e., the issuer 108 would lose revenue by declining the transaction), the impact engine 116 will determine, at 316, that the net revenue satisfies the threshold when the net revenue is negative (or potentially zero). As such, when the net revenue satisfies the threshold, as in the above example (where the net revenue is −$7.91), the impact engine 116 permits the transaction to proceed, at 318, which may be understood to indicate overruling the decline of the transaction indicated by the fraud scheme of the issuer 108 (and despite the authorization reply for the transaction including the indicator to decline the transaction for fraud). Conversely, if the net revenue does not satisfy the threshold (e.g., the net revenue for the issuer 108 in connection with declining the transaction is positive, etc.), the impact engine 116 permits the transaction to be declined, at 320.

It should be appreciated that while the impact engine 116 is described as performing operations 316, 318, and 320 in this embodiment of the method 300, the payment network 106 and/or the issuer 108 may perform one or more of these operations (and/or other operations) in other embodiments of the method 300. More generally, as the impact engine 116 is incorporated, or not, in the payment network 106 and/or the issuer 108, any of the operations described above may be accomplished and/or perform by the payment network 106 and/or issuer 108 despite the exclusive description of the same with reference to the impact engine 116 above.

In another implementation of the exemplary method 300, the consumer 112 performs a transaction at the merchant 102 in the amount of $600. In response, the merchant 102 transmits an authorization request for the transaction to the issuer 108, as described above in the system 100. And, as above, the issuer 108 employs one or more fraud schemes in evaluating the transaction and determines in this example, based on the fraud scheme(s), that the transaction is suspicious for fraud (e.g., the transaction involves an amount larger than a predefined amount for the given payment account, etc.). In turn, the issuer 108 generates an authorization reply for the transaction and includes an indicator of decline for the transaction in the reply, based on the suspicion of fraud. And, the impact engine 116 receives the indicator of decline for the transaction, via the authorization reply, at 302.

The impact engine proceeds in the method 300 as generally described above, and next identifies the consumer 112 to Segment #2 (i.e., the consumer 112 is a 25 year old male with an annual income of $54,650, no children, and a residence within the 12345 postal code), at 306 (e.g., from Table 1 above, etc.), and further identifies a spending change value associated with Segment #2 of 4%, at 308 (e.g., from Table 2 above, etc.). The impact engine 116 also determines the CESV for the consumer's payment account, at 310 (as described above in the system 100), which is determined to be $20,000. And, based on the interchange rate (IR) for the issuer 108 of 1.6%, the impact engine 116 determines the CFLV for the payment account to be $320. Next, at 312, the impact engine 116 retrieves, from the data structure 118, the fraud rate for the issuer 108 of 5%, the interchanges rate (IR) for the issuer 108 of 1.6%, and the PFPD for the issuer 108 of 80%.

With the above, the impact engine 116 then determines a net revenue for the decline of the consumer's transaction, at 314, based on the above algorithm. In particular, as shown below, the impact engine 116 determines the net revenue to be $10.16.

Net Revenue=(5%*$600)−(1.6%*$600)−(80%*4%*$320)=$10.16

Finally, the impact engine 116 determines whether the net revenue satisfies, or not, the $0.00 threshold from above. In this example, the net revenue is positive (i.e., $10.16) and does not satisfy the threshold, at 316 (i.e., it is more profitable to decline the transaction than override the decline and allow the transaction). As such, the impact engine 116 permits the transaction to be declined, at 320, in this example.

In view of the above, the systems and methods herein permit an impact engine to be employed to incorporate future expected value (or revenue) to be considered in determining whether, or not, to ultimately decline a transaction based on a suspicion of fraud (as opposed to a mere cost-benefit analysis for the particular transaction). By doing so, the issuer or other entity (e.g., the payment network, etc.) is able to avoid making decisions of a potential immediate loss, at the risk of losing potentially substantial future revenues for consumers who would change their behavior and use of the payment account from the issuer in response to one or more false positive declines. In this manner, the systems and methods herein take into account the consumer's future behaviors in using or not using the payment account, depending on the consumer (or segment of the consumer), which is unconventional, yet a more appropriate indicator of when a transaction should be declined or not, when a suspicious of fraud exists.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) identifying a segment for a consumer, based on at least one demographic factor associated with the consumer; (b) retrieving a change in spending value associated with the identified segment; (c) determining a net revenue for decline of a transaction to a payment account associated with the consumer, based on the change in spending value and at least one of a future spending value, an interchange rate for an issuer of the payment account, and a rate of false positive declines for the issuer; and (d) comparing the net revenue to at least one threshold, wherein the transaction is able to be permitted when the at least one threshold is satisfied despite the transaction having an associated indicator of fraud.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include, without limitation, a good, a service, etc.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for permitting a transaction having an associated indicator of fraud, the computer-implemented method comprising:
identifying, by a computing device, a segment for a consumer, based on at least one demographic factor associated with the consumer;
retrieving, by the computing device, a change in spending value associated with the identified segment;
determining, by the computing device, a net revenue for decline of a transaction to a payment account associated with the consumer, based on the change in spending value and at least one of a future spending value, an interchange rate for an issuer of the payment account, and a rate of false positive declines for the issuer; and
comparing the net revenue to at least one threshold, wherein the transaction is able to be permitted when the at least one threshold is satisfied despite the transaction having an associated indicator of fraud.

2. The computer-implemented method of claim 1, wherein the at least one demographic factor includes an age of the consumer, an income of the consumer, and/or a location of the consumer.

3. The computer-implemented method of claim 1, wherein the at least one demographic factor includes at least one of a number of children of the consumer and a gender of the consumer.

4. The computer-implemented method of claim 1, further comprising receiving an indicator of decline for the transaction based on the associated indicator of fraud;
directing the transaction to be approved, despite the indicator of decline, when the net revenue satisfies the at least one threshold; and
permitting the transaction to be declined, when the net revenue fails to satisfy the at least one threshold.

5. The computer-implemented method of claim 4, wherein the at least one threshold is about 0.

6. The computer-implemented method of claim 1, wherein determining the net revenue is based on the future spending value, the interchange rate, and the rate of false positive declines and is further based on a fraud rate.

7. The computer-implemented method of claim 1, further comprising determining the future spending value of the consumer based on at least historical transaction data for said payment account.

8. The computer-implemented method of claim 7, wherein determining the future spending value of the consumer is further based on an issuer associated with the payment account, a location associated with the issuer and/or a type of the payment account.

9. The computer-implemented method of claim 1, further comprising identifying the change in spending value based on a condition of the transaction; and
wherein the condition includes whether the transaction is a card-present transaction or a card-not-present transaction.

10. The computer-implemented method of claim 1, further comprising determining the change in spending value associated with the identified segment, prior to identifying the segment, based on a set of affect transaction data and a set of control transaction data; and
wherein the affect transaction data includes at least one false positive declined transaction.

11. A system for use in permitting a transaction having an associated indicator of fraud, the system comprising:
a memory configured to store a change value for each of multiple segments of consumers; and
a processor coupled to the memory and configured to:
in response to a transaction by a consumer, identify a change value for the transaction based on a payment account involved in the transaction;
determine a net revenue for a decline of the transaction, based on the identified change value and a consumer expected spending value for the consumer; and
permit the transaction to proceed when the net revenue satisfies at least one threshold.

12. The system of claim 11, wherein the processor is further configured to permit the transaction to be declined when the net revenue fails to satisfy the at least one threshold.

13. The system of claim 11, wherein the consumer expected spending value is based on at least two of an issuer associated with the payment account, a country associated with the issuer, and a transaction history of the payment account.

14. The system of claim 11, wherein the processor is further configured to identify a segment associated with the payment account and/or the consumer; and to identify the change value based on the identified segment.

15. The system of claim 14, wherein the segment is defined by at least one of a demographic and historical spending profile.

16. The system of claim 11, wherein the processor is configured to determine the net revenue further based on an interchange rate associated with an issuer of the payment account, an amount of the transaction, and a fraud rate associated with the issuer and/or the transaction.

17. A non-transitory computer readable storage media including executable instructions for processing a potentially fraudulent transaction, which, when executed by at least one processor, cause the at least one processor to:
determine a net revenue associated with a decline of a transaction to a payment account based on a value associated with a future expected spending of a consumer, the consumer associated with the payment account;
direct the transaction to not be declined when the net revenue satisfies a threshold; and
permit the transaction to be declined when the net revenue fails to satisfy the threshold.

18. The non-transitory computer readable storage media of claim 17, wherein the executable instructions, when executed by the at least one processor, further cause the at least one processor to:
identify a value change for the consumer associated with a false positive decline of the transaction; and
determine the net revenue further based on the value change, a fraud rate, and an interchange rate associated with an issuer of the payment account.

19. The non-transitory computer readable storage media of claim 18, wherein the executable instructions, when executed by the at least one processor, further cause the at least one processor to identify the value change for the consumer associated with the false positive decline of the transaction based on a set of affected transaction data and a set of control transaction data.

20. The non-transitory computer readable storage media of claim 17, wherein the net revenue includes a net revenue score.
